(19) United States
(12) Patent Application Publication
(10) Pub. No.: US 2012/0246569 A1
(43) Pub. Date: Sep. 27, 2012

(54) GENERATING A PERSONAL TOPOLOGY DURING INDUCTIVE CHARGING AND DATA TRANSFER

(76) Inventors: Eric Liu, Sunnyvale, CA (US); Manjirnath Chatterjee, Sunnyvale, CA (US); William Grange, Sunnyvale, CA (US)

(21) Appl. No.: 13/053,498

(22) Filed: Mar. 22, 2011

(51) Int. Cl. G06F 3/01

(52) U.S. Cl. 715/738

(57) ABSTRACT

Illustrated is a system and method to detect an inductively received electrical charge, the electrical charge received from a form factor capable of inductively charging and exchanging data with a mobile computing device. The system and method also includes displaying a user interface (UI) on the mobile computing device, the UI to receive input to instantiate a node that represents the form factor. Additionally, the system and method includes associating the node with a map to be displayed on the mobile computing device.

### CROSS REFERENCE TO RELATED APPLICATIONS

This application is related to U.S. patent application Ser. No. 12/478,766, filed Jun. 4, 2009, entitled INDUCTIVE SIGNAL TRANSFER SYSTEM FOR COMPUTING DEVICES; which is a continuation-in-part of U.S. patent application Ser. No. 12/239,656, filed Sep. 26, 2808, entitled ORIENTATION AND PRESENCE DETECTION FOR USE IN CONFIGURING OPERATIONS OF COMPUTING DEVICES IN DOCKED ENVIRONMENTS, which claims benefit of priority to the following applications: Provisional U.S. Patent Application No. 61/142,560, filed Jan. 5, 2009, entitled ELECTRICAL APPARATUS FOR REAL TIME WIRELESS POWER DELIVERY; Provisional U.S. Patent Application No. 61/142,194, filed Dec. 31, 2808, entitled PROTOCOL FOR REAL TIME POWER AND ACCESSORY DATA CONNECTION; Provisional U.S. Patent Application No. 61/142,195, filed Jan. 1, 2009, entitled TECHNIQUES FOR MAGNETICALLY COUPLING CHARGING CIRCUITS AND DEVICES; Provisional U.S. Patent Application No. 61/142,602, filed Jan. 5, 2009, entitled MAGNETIC CLASP WITH MULTIPLE ORIENTATIONS AND ORIENTATION DETECTION; all of the aforementioned priority applications being hereby incorporated by reference in their entirety.

### BACKGROUND

A Location-Based Service (LBS) is an information or entertainment service, accessible with mobile devices through a mobile network that utilizes the ability to make use of the geographical position of the mobile device. LBS can be used in a variety of contexts, such as health, work, or personal life. LBS include services to identify a location of a person or object, such as discovering the nearest banking cash machine or the whereabouts of a friend or employee. LBS can include parcel tracking and vehicle tracking services. LBS can also include mobile commerce when taking the form of coupons or advertising directed at customers based on their current location.

### BRIEF DESCRIPTION OF THE DRAWINGS

Some embodiments of the invention are described, by way of example, with respect to the following figures:

FIG. 1a illustrates one embodiment of a mobile computing device, according to an example embodiment, that is used to implement a LBS with the mobile computing device.

FIG. 1b illustrates one embodiment of a mobile computing device, according to an example embodiment, that is used to implement a LBS with the mobile computing device.

FIG. 2 is a diagram of an LBS system, according to an example embodiment, that identifies a station capable of providing inductive charging and data transfer capabilities to a mobile computing device.

FIG. 3 is a diagram of an LBS system, according to an example embodiment, that identifies a printer capable of providing inductive charging and data transfer capabilities to a mobile computing device.

FIG. 4 is a diagram of an LBS system, according to an example embodiment, that identifies a monitor capable of providing inductive charging and data transfer capabilities to a mobile computing device.

FIG. 5 is a diagram of a view, according to an example embodiment, illustrating a personal map of a building floor.

FIG. 6 is a diagram of a view, according to an example embodiment, illustrating a personal map of a retail area in the form of a mall.

FIG. 7 is a diagram of a mobile computing device, according to an example embodiment and screen included therein, that shows the personal map.

FIG. 8 is a diagram of a mobile computing device, according to an example embodiment and screen included therein, that shows a personal map.

FIG. 9 is a block diagram, according to an example embodiment, of an architecture of a mobile computing device, enabled to detect motion generated from gestures.

FIG. 10 is a diagram of a mobile computing device, according to an example embodiment, that is used to generate a personal network topology through the use of a form factor with inductive charging and data transfer capabilities.

FIG. 11 is a diagram of a system, according to an example embodiment, to generate a personal network topology through assigning data to a form factor, allowing the form factor to know its location in a map.

FIG. 12 is a flow chart illustrating a method, according to an example embodiment, to generate a personal network topology through the use of a form factor with inductive charging and data transfer capabilities.

FIG. 13 is a flow chart illustrating a method, according to an example embodiment, to implement the node designation logic.

FIG. 14 is a flow chart illustrating a method, according to an example embodiment, to execute operation that retrieves a base map.

FIG. 15 is a dual-stream flow chart illustrating a method, according to an example embodiment, to generate a personal network topology through assigning data to a form factor, allowing the form factor to know its location in a map.

### DETAILED DESCRIPTION

Illustrated is a system and method to implement a LBS, wherein a personal network topology is generated through the use of a form factor with inductive charging and data transfer capabilities. As used herein, a personal network topology is a graph network wherein each node in the graph network is a form factor with inductive charging and data transfer capabilities. Example form factors include a docking station, a printer, a monitor, a computer system, or some other suitable device capable of being used to inductive charge and/or transfer data to a mobile computing device. The mobile computing device may be a smart phone, cell phone, state or tablet computer, or other suitable portable computer system. This personal network topology is associated with a base map to create a personal map. The base map may be a Mercator projection or other two dimensional or three dimensional representation of an area. Associated, as used herein, may include layering on top of or super imposing onto the base map. This base map may be a generated through the use of a collection of images (e.g., Joint Photographic Experts Group (JPEG) formatted images), each image representing a portion of the base map. Examples of a base map include a building floor plan, a map or other suitable diagram. The base map may be retrieved from memory residing on the form factor or the portable device.

In some example embodiments, the portable device physically interacts with the form factor so as to instantiate a node within the personal network topology. Physically interacts includes touches, or to become physically proximate so as to allow for inductive charging to take place between the form factor and the portable device. Inductive charging and data transfer is described in U.S. Pat. No. 7,065,658 titled “Method and apparatus for synchronizing and recharging a connector-less portable computer system” which is incorporated by reference in its entirety. The instantiated node may be associated with the base map so as to identify a particular location on the personal map. Certain types of additional data may be provided by the portable device associated no as to additionally describe the node. This data may include Global Positioning System (GPS) data, name data, a Globally Unique Identifier (GUID) value, an Internet Protocol Address (e.g., IPv4 or IPv6), a Media Access Control (MAC) Address, or other data to uniquely identify the node on the personal map. This location data provided by the phone can then also be stored on the node so that this information could be used with other devices.

In some example embodiments, the personal map is generated so as to allow a user to navigate an area to find nodes that are of interest to the user as part of a general LBS. For example, a user can use the personal map to find a printer, or monitor in an office. Additionally, the user may use the personal map to find a store, restaurant or other location in a retail space, where the store, restaurant or other location is represented as having a node. In one example embodiment, in cases where the portable device and the form factor interact, an advertisement is shown on the personal map in lieu of or in addition to the node. For example, if a smart phone taps an inductive charging and data transfer station located in a restaurant, the personal map may show a daily meal special at the location of the restaurant on the personal map.

In some example embodiments, GPS coordinates from a mobile computing system is uploaded to the node, allowing the node (e.g., a printer) to have location awareness without the use of a GPS system. In such a use case, the base map may already exists in the mobile computing device or as part of another device operatively connected to the network domain. A user may tapping the form factor no as to give the mobile computing device a form factor ID (e.g., GPS data, or a GUID) which is associated with GPS coordinates provided by the mobile computing device. The GPS coordinates are provided to the form factor (e.g., the printer) allowing the form factor to know its location. In some example embodiments, some type of triangulation may be used to determine the location of the form factor. This triangulation may be Radio Frequency (RF) based, cellular based (e.g., Code Divisional Multiple Access (CDMA), Universal Mobile Telecommunications System (UTMS)), or based upon protocol such as WiFi (802.11), WiMax (802.16), or some other suitable protocol.

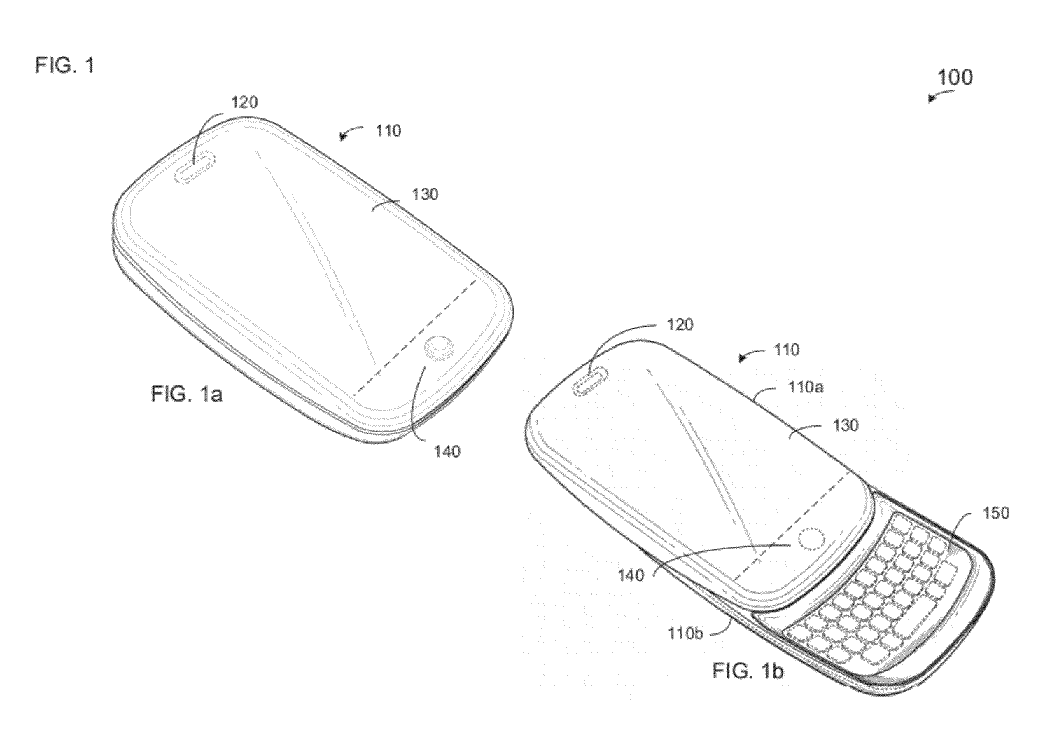

FIGS. 1a and 1b illustrate one embodiment of a mobile computing device 110 that is used to implement a LBS with the mobile computing device 110. FIG. 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, slate device, smartphone, netbook, or laptop computer. The mobile computing device 110 is configured to host and execute a phone application for placing and receiving telephone calls. In one example embodiment, the configuration as disclosed may be configured for use between a mobile computing device, that may be host device, and an accessory device.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with Public Switched Telephone Networks (PSTN) and/or data networks having Voice over Internet Protocol (VoIP) functionality. Likewise, the mobile computing device 110 is only by way of example, and the principles of its functionality apply to other computing devices, e.g., desktop computers, slate devices, server computers and the like.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a Personal Digital Assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. In one embodiment the screen may be 1.5 inches to 5.5 inches (or 4 centimeters to 14 centimeters) diagonally. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an Active-matrix OLED (AMOLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACT FLASH, SD CARD, XD CARD, MEMORY STICK, MULTIMEDIA CARD, SDIO, and the like.

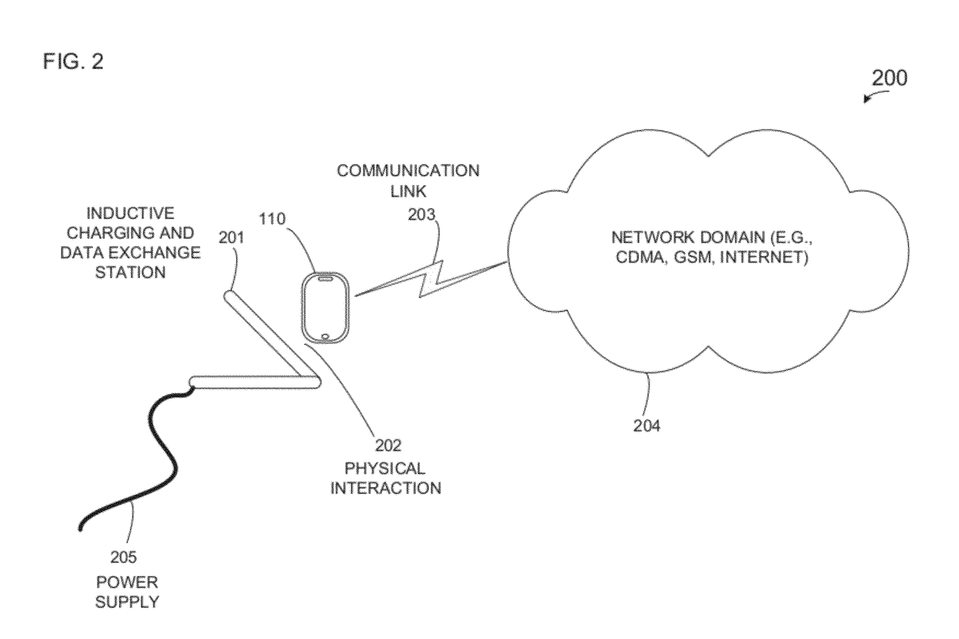

FIG. 2 is a diagram of an example LBS system 200 that identifies a station capable of providing inductive charging and data transfer capabilities to a mobile computing device. Shown is the mobile computing device 110 that, as denoted at 202, physically interacts with an inductive charging and data exchange station 201. A power supply 205 provides electrical power, and in some cases data, to the inductive charging and data exchange station 201. This mobile computing device 110 may be operatively connected to a network domain 204 via a communication link 203. Operatively connected, as used herein, includes a physical or logical connection. The network domain 204 may be an Internet, Code Division Multiple Access (CDMA), Global System for Mobile Communication (GSM), Universal Mobile Telecommunications System (UMTS), or other suitable network domain. In some example embodiments, a base map is uploaded to the mobile computing device 110 where a physical interaction 202 occurs between the mobile computing device 110 and the inductive charging and data exchange station 201. In some example embodiments, this base map is downloaded to the mobile computing device 110 via the network domain 204. In one example embodiment, the physical interaction 202 between the mobile computing device 110 and the inductive charging and data exchange station 201 causes a node to be instantiated as part of the personal network topology and to appear on a personal map that can be further displayed on the mobile computing device 110.

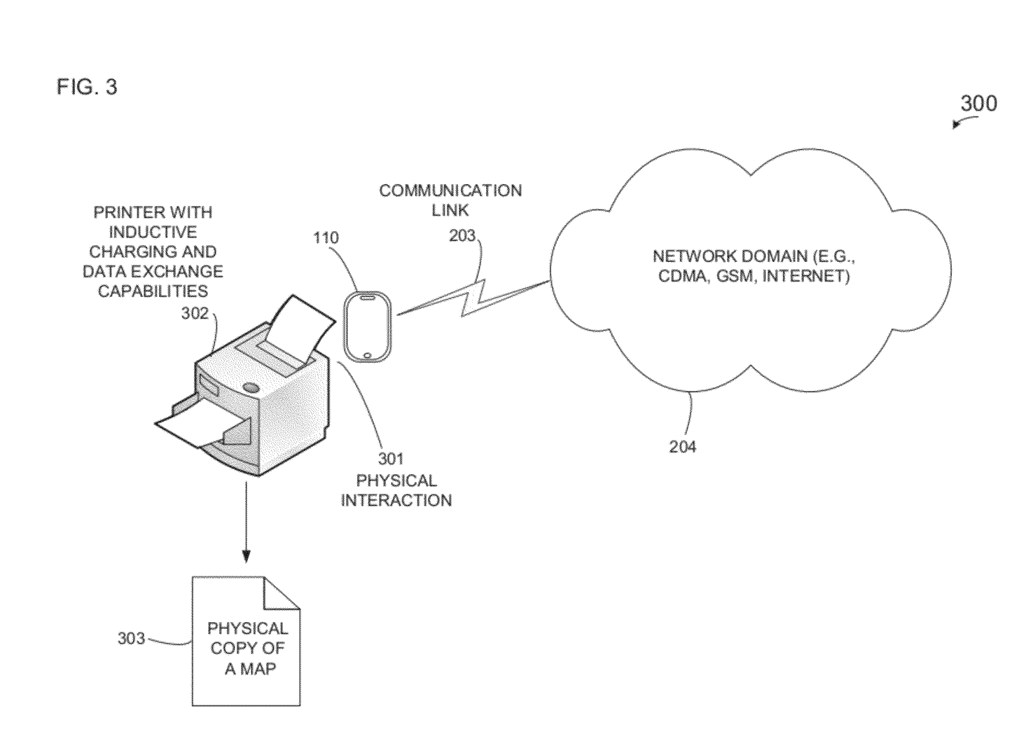

FIG. 3 is a diagram of an example LBS system 300 that identifies a printer capable of providing inductive charging and data transfer capabilities to a mobile computing device. Shown is a mobile computing device 110 that, as illustrated at 301, physically interacts with a printer 302 with inductive charging and data transfer capabilities. This physical interaction 301 may cause a base map to be uploaded to the mobile computing device 110 from the printer 302. This physical interaction 301 may cause the base map to be downloaded to the mobile computing device 110 from the network domain 204. In one example embodiment, the physical interaction 301 between the mobile computing device 110 and the printer 302 causes a node to be instantiated as part of the personal network topology and to appear on a personal map that can be further displayed on the mobile computing device 110. In some example embodiments, in cases where this physical interaction 301 occurs, the printer generates a physical copy 303 of a personal map. The personal map showing the location of the printer 302. In some cases, the physical copy 303 of the personal map may show the GPS based coordinates of the printer 302, these coordinates supplied by the mobile computing device 110.

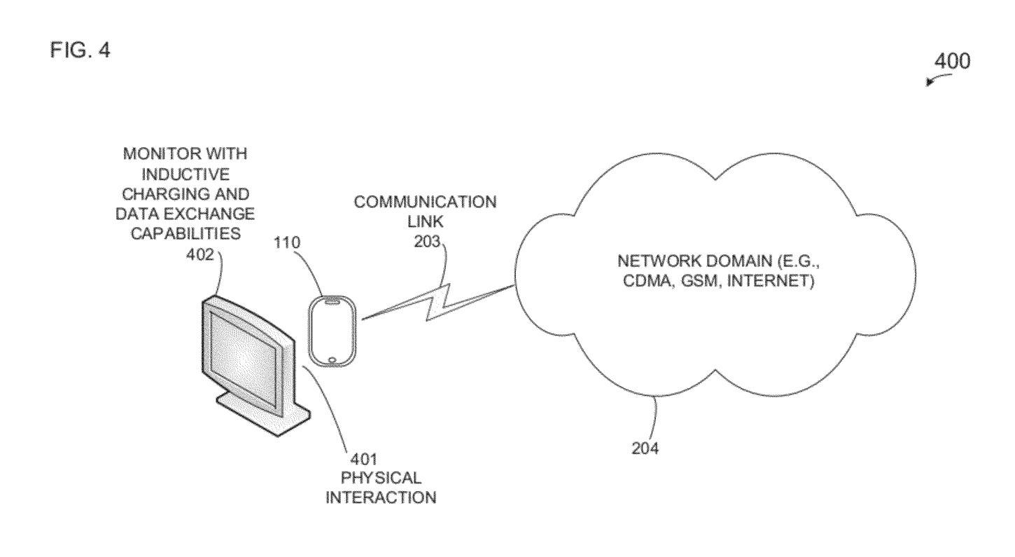

FIG. 4 is a diagram of an example LBS system 400 that identities a monitor capable of providing inductive charging and data transfer capabilities to a mobile computing device. Shown is a mobile computing device 110 that, as illustrated at 401, physically interacts with a monitor 402 with inductive charging and data transfer capabilities. This physical interaction 401 may cause a base map to be uploaded to the mobile computing device 110 from the monitor 402. This physical interaction 401 may cause the base map to be downloaded to the mobile computing device 110 from the network domain 204. In one example embodiment, the physical interaction 401 between the mobile computing device 110 and the monitor 402 causes a node to be instantiated as part of the personal network topology and to appear on a personal map that can be further displayed on the mobile computing device 110. This personal map may also be displayed on the monitor 402.

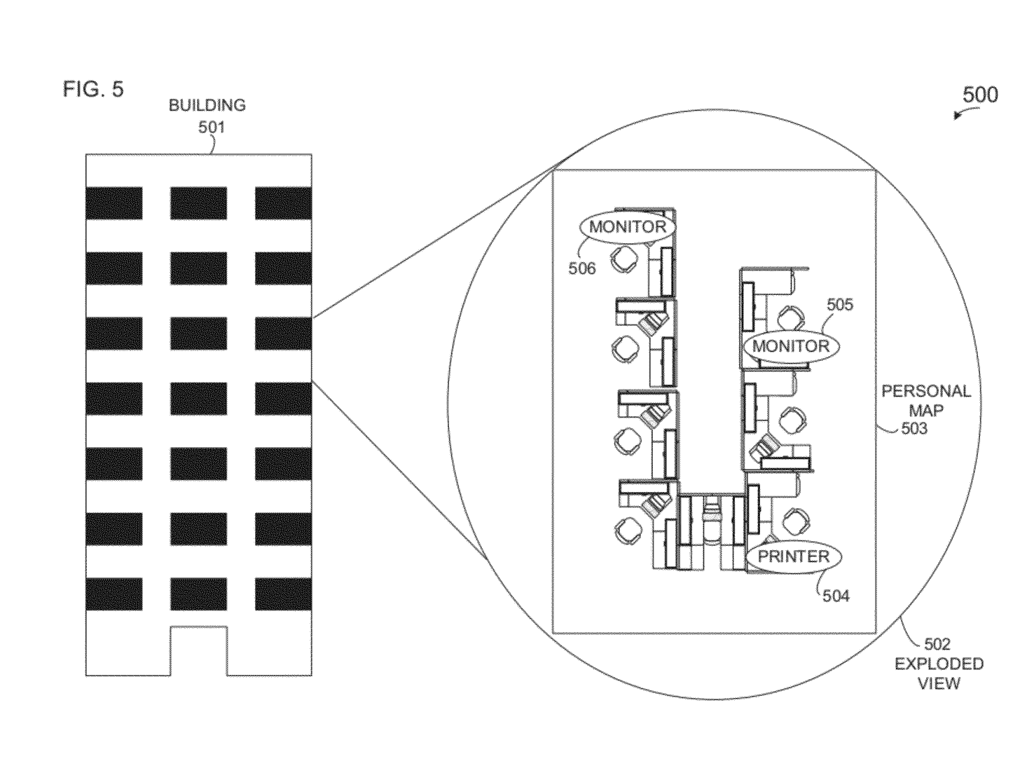

FIG. 5 is a diagram of an example view 500 illustrating a personal map of a building floor. Shown is a building 501 and an exploded view 502 of a floor of the building 501. Included in the exploded view 502, is a personal map 503 that shows a base map in the form of a floor plan, and a plurality of nodes that make up a personal network topology. These nodes include a node 504 identifying a printer, a node 505 identifying a monitor, and a node 506 identifying a monitor. Each of the devices identified by the nodes 504-506 is capable of inductive charging and data transfer. As will be shown below, this personal map 503 may be displayed by the mobile computing device 110.

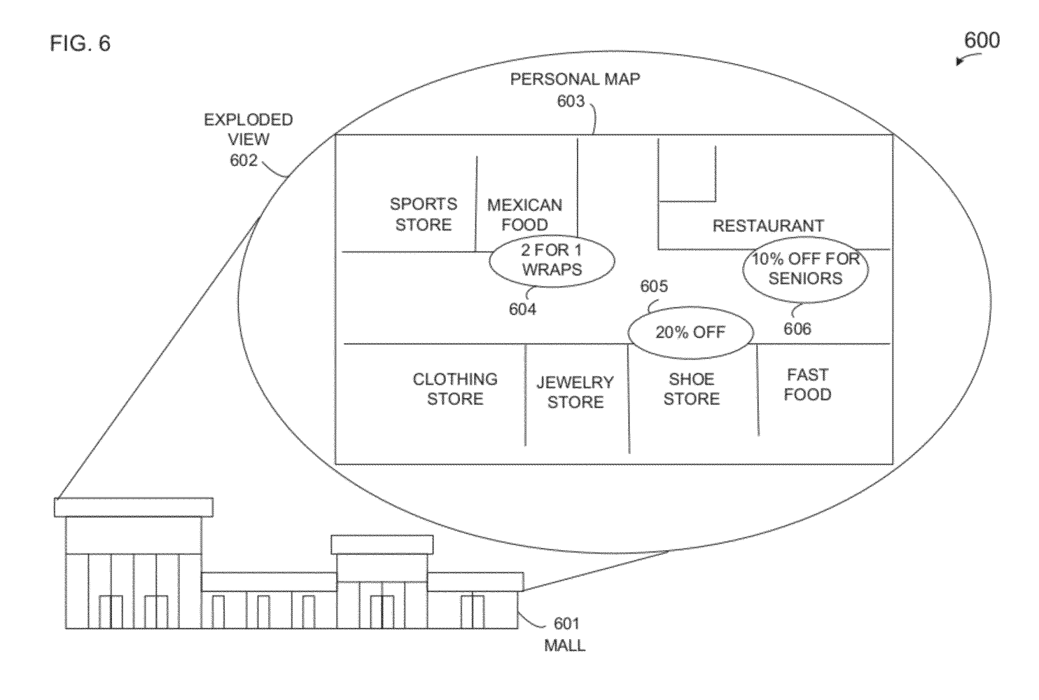

FIG. 6 is a diagram of an example view 600 illustrating a personal map of a retail area in the form of a mall 601. Shown is a mall 601 and an exploded view 602 of the retail area of the mall 601. Included in the exploded view 602, is a personal map 603 that shows a base map in the form of a retail area map, and a plurality of nodes that make up a personal network topology. These nodes include a node 604 in the form of an advertisement for a Mexican restaurant, a node 605 in the form of an advertisement for a shoe store, and a node 606 in the form of an advertisement for a restaurant. The personal map 603 is provided to a mobile computing device 110 via a form factor capable of inductive charging and data transfer. As will be shown below, this personal map 603 may be displayed by the mobile computing device 110.

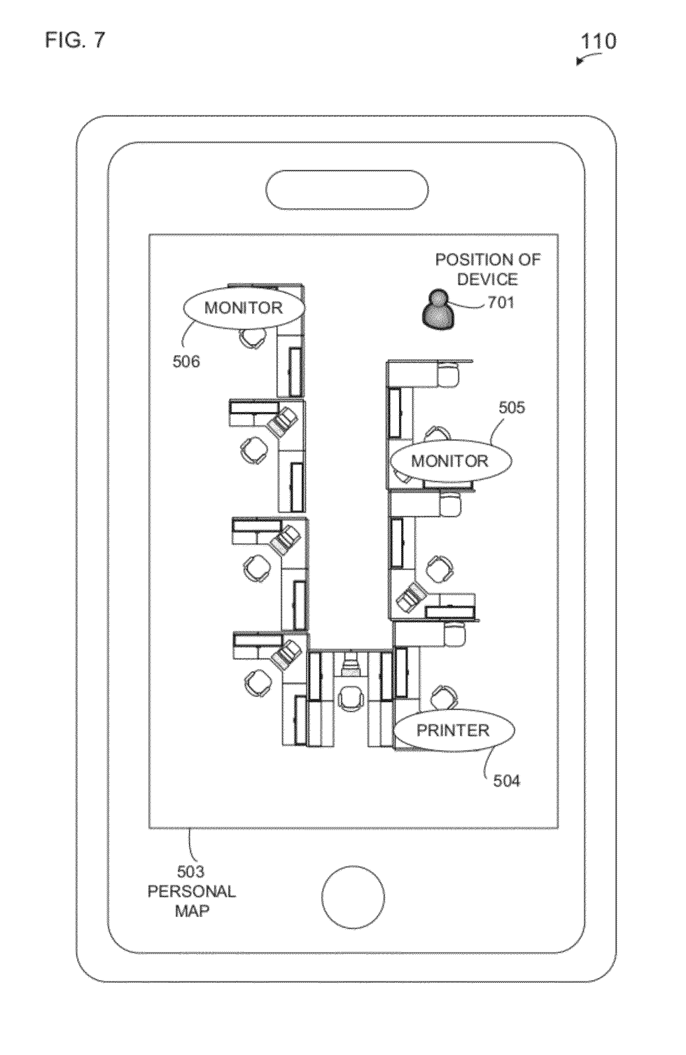

FIG. 7 is a diagram of a mobile computing device 110 and screen included therein that shows the personal map 503. Shown is the personal map 503 on the screen 130 of the mobile computing device 110. Also shown, is the position of the mobile computing device 110, referenced at 701, relative to the nodes 504-506. Using this position of the mobile computing device, a user may avail themselves of the monitors (denoted at 505-506), or the printer (denoted at 504).

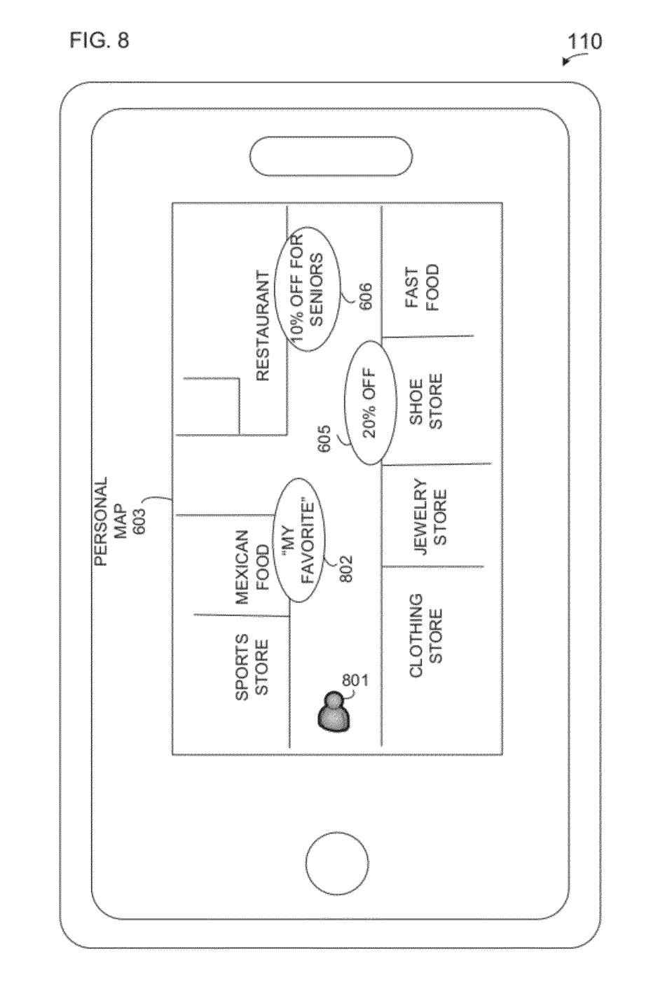

FIG. 8 is a diagram of an example mobile computing device 110 and screen included therein that shows the personal map 603. Shown is the personal map 603 on the screen 130 of the mobile computing device 110. Also shown, is the position of the mobile computing device 110, referenced at 801, relative to the nodes 802 and 605-606. Aliasing may be used to designate a particular node such that a node may be custom labeled by a user. Here, for example, the node 604 is relabeled with the title “My Favorite”. Using the position of the mobile computing device, shown at 801, a user may avail themselves of the advertised specials for establishment identified in the personal map 603.

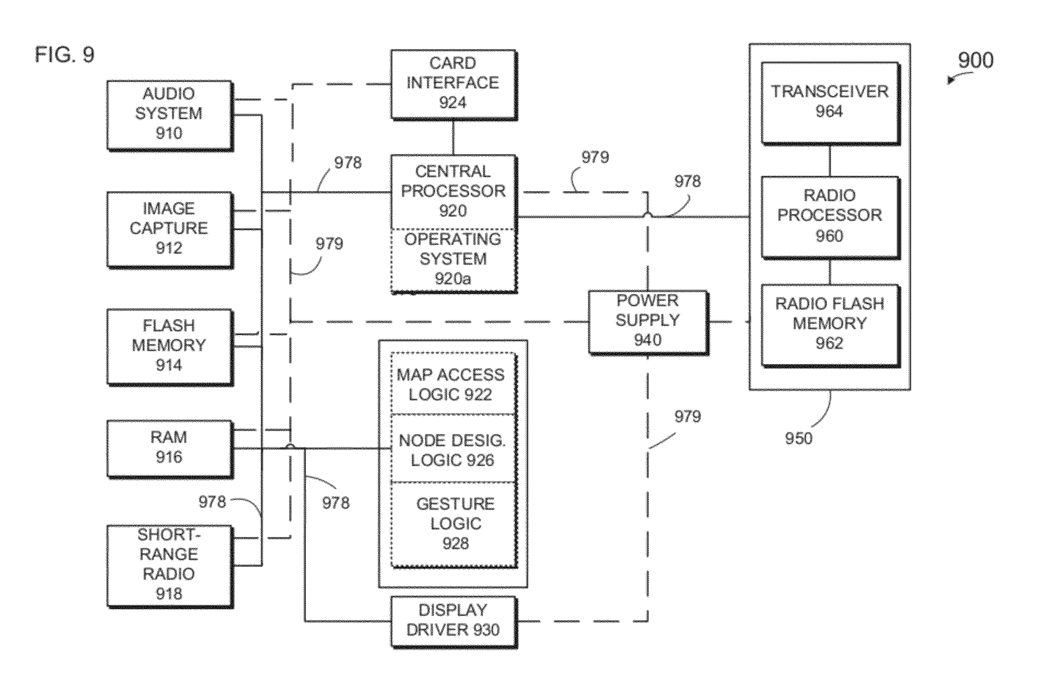

Referring next to FIG. 9, a block diagram illustrates an example architecture of a mobile computing device 110, enabled to detect motion generated from gestures. By way of example, the architecture illustrated in FIG. 9 will be described with respect to the mobile computing device of FIGS. 1a, 1b, 3, 4, or 5. The mobile computing device 110 includes a central processor 920, a power supply 940, and a radio subsystem 950. Examples of a central processor 920 include processing chips and system based on architectures such as ARM (including cores made by microprocessor manufacturers), ARM XSCALE, QUALCOMM SNAPDRAGON, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 920 is configured for operation with a computer operating system 920a. The operating system 920a is an interface between hardware and an application, with which a user typically interfaces. The operating system 920a is responsible for the management and coordination of activities and the sharing of resources of the mobile computing device 110. The operating system 920a provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LINUX.

The central processor 920 communicates with an audio system 910, an image capture subsystem (e.g., camera, video or scanner) 912, flash memory 914, RAM memory 916, and a short range radio module 918 (e.g., Bluetooth, Wireless Fidelity (WiFi) component (e.g., IEEE 802.11, 802.20, 802.15, 802.16)). The central processor 920 communicatively couples these various components or modules through a data line (or bus) 978. The power supply 940 powers the central processor 920, the radio subsystem 950 and a display driver 930 (which may be contact- or inductive-sensitive). The power supply 940 may correspond to a direct current source (e.g., a battery pack, including rechargeable) or an alternating current (AC) source. The power supply 940 powers the various components through a power line (or bus) 979.

The central processor communicates with applications executing within the mobile computing device 110 through the operating system 920a. In addition, intermediary components, for example, a map access logic module 922 and a node designation logic 926, provide additional communication channels between the central processor 920 and operating system 920 and system components, for example, the display driver 930. The map access logic module 922 executes logic to retrieve base maps.

It is noted that in one embodiment, central processor 920 executes logic (e.g., by way of programming, code, or instructions) corresponding to executing applications interfaced through, for example, the navigation area 140 or switches. It is noted that numerous other components and variations are possible to the hardware architecture of the computing device 900, thus an embodiment such as shown by FIG. 9 is just illustrative of one implementation for an embodiment.

In one example embodiment, a node designation logic module 926 is shown that is software (e.g., integrated with the operating system) or firmware (lower level code that resides is a specific memory for that code and for interfacing with specific hardware, e.g., the processor 920). The node designation logic module 926 is configured to receive data identifying a particular device as capable of providing inductive charging and data transfer capabilities.

In one example embodiment, a gesture logic module 928 is shown that is software (e.g., integrated with the operating system) or firmware (lower level code that resides is a specific memory for that code and for interfacing with specific hardware, e.g., the processor 920). This gesture logic module 928 is executed to determine the gesture associated with instantiating a node.

The radio subsystem 950 includes a radio processor 960, a radio memory 962, and a transceiver 964. The transceiver 964 may be two separate components for transmitting and receiving signals or a single component for both transmitting and receiving signals. In either instance, it is referenced as a transceiver 964. The receiver portion of the transceiver 964 communicatively couples with a radio signal input of the device 110, e.g., an antenna, where communication signals are received from an established call (e.g., a connected or on-going call). The received communication signals include voice (or other sound signals) received from the call and processed by the radio processor 960 for output through the speaker 120. The transmitter portion of the transceiver 964 communicatively couples a radio signal output of the device 110, e.g., the antenna, where communication signals are transmitted to an established (e.g., a connected (or coupled) or active) call. The communication signals for transmission include voice, e.g., received through the microphone of the device 110, (or other sound signals) that is processed by the radio processor 960 for transmission through the transmitter of the transceiver 964 to the established call.

In one embodiment, communications using the described radio communications may be over a voice or data network. Examples of voice networks include GSM communication system, a CDMA system, and a UMTS. Examples of data networks include General Packet Radio Service (GPRS), third-generation (3G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 950, the basic components shown provide the ability for the mobile computing device to perform radio-frequency communications, including telephonic communications. In an embodiment, many, if not all, of the components under the control of the central processor 920 are not required by the radio subsystem 950 when a telephone call is established, e.g., connected or ongoing. The radio processor 960 may communicate with central processor 920 using the data line (or bus) 978.

The card interface 924 is adapted to communicate, wirelessly or wired, with external accessories (or peripherals), for example, media cards inserted into the expansion slot (not shown). The card interface 924 transmits data and/or instructions between the central processor and an accessory, e.g., an expansion card or media card, coupled within the expansion slot. The card interface 924 also transmits control signals from the central processor 920 to the expansion slot to configure the accessory. It is noted that the card interface 924 is described with respect to an expansion card or media card; it also may be structurally configured to couple with other types of external devices for the device 110, for example, an inductive charging station for the power supply 940 or a printing device.

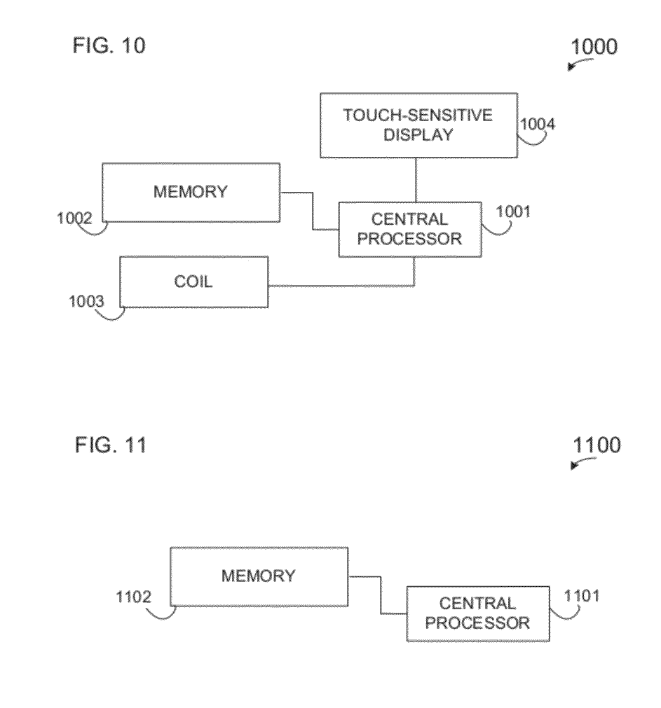

FIG. 10 is a diagram of an example mobile computing device 1000 that is used to generate a personal network topology through the use of a form factor with inductive charging and data transfer capabilities. This mobile computing device 1000 may be the mobile computing device 110. Shown is a central processor 1001 operatively coupled to a memory 1002. An example of the central processor 1001 is the central processor 920. Operatively coupled includes a logical or physical connection. Operatively coupled to the central processor 1001 is a coil 1003 capable of receiving an electrical charge from a form factor, the form factor capable of inductively charging and exchanging data with the mobile computing device 110. Operatively coupled to the central processor 1001 is a touch-sensitive display 1004 capable of receiving input to instantiate a node that represents the form factor, the node part of a personal network topology. The memory 1002 is used to store the personal network topology associated with a map. In some example embodiments, the personal map includes a floor plan. In some example embodiments, the touch-sensitive display 1004 receives instructions to retrieve additional data, the additional data to describe the node as the node is displayed on the touch-sensitive screen. Further, the additional data may include at least one of GPS data, IP address, MAC address, name data, or a GUID value. The map may be retrieved from the form factor.

FIG. 11 is a diagram of an example system 1100 to generate a personal network topology through assigning data to a form factor, allowing the form factor to know its location in a map. This system 1100 may be a mobile computing device 110. Shown is a central processor 1101 operatively connected to a memory 1102. The memory 1102 is in communication with the central processor 1101, the memory 1102 including logic encoded in one or more tangible media for execution and when executed operable to detect an inductively received electrical charge, the electrical charge received from a form factor capable of inductively charging and exchanging data with a mobile computing device. Additionally, the logic is encoded in one or more tangible media for execution and when executed operable to display a UI on the mobile computing device, the UI to receive input to instantiate a node that represents the form factor. Further, the logic is encoded in one or more tangible media for execution and when executed operable to associate location information for the node with a map to be displayed on the mobile computing device. Moreover, the logic is encoded in one or more tangible media for execution and when executed operable to transmit the location information to the form factor. The logic is encoded in one or more tangible media for execution and when executed operable to get the location information from a location system. In some example embodiments, the location system uses triangulation and includes at least one of a RF based location system, a cellular based location system, a WiFi based location system, or a WiMax based location system. In some example embodiments, the computer system is a mobile computing device.

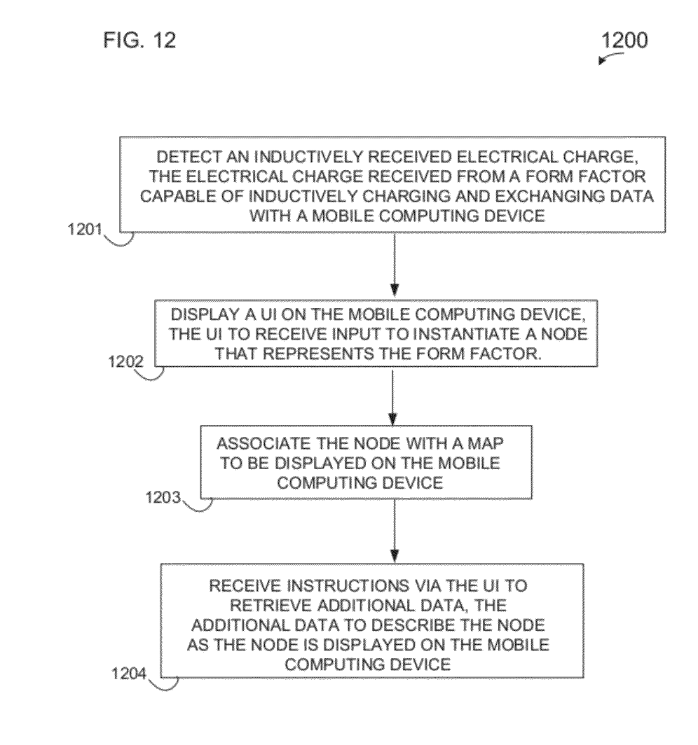

FIG. 12 is a flow chart illustrating an example method 1200 to generate a personal network topology through the use of a form factor with inductive charging and data transfer capabilities. This method 1200 may be implemented by the mobile computing device 110. Operation 1201 is executed to detect an inductively received electrical charge, the electrical charge received from a form factor capable of inductively charging and exchanging data with a mobile computing device. Operation 1202 is executed to display a UI on the mobile computing device, the UI to receive input to instantiate a node that represents the form factor. Operation 1203 is executed to associate the node with a map to be displayed on the mobile computing device. In some example embodiments, the form factor is at least one of a printer, or a monitor. Additionally, in some example embodiments, the node is part of a personal network topology. Operation 1204 is executed to receive instructions via the UI to retrieve additional data, the additional data to describe the node as the node is displayed on the mobile computing device. In some example embodiments, the additional data includes at least one of GPS data, IP data, MAC data, name data, or a GUID value.

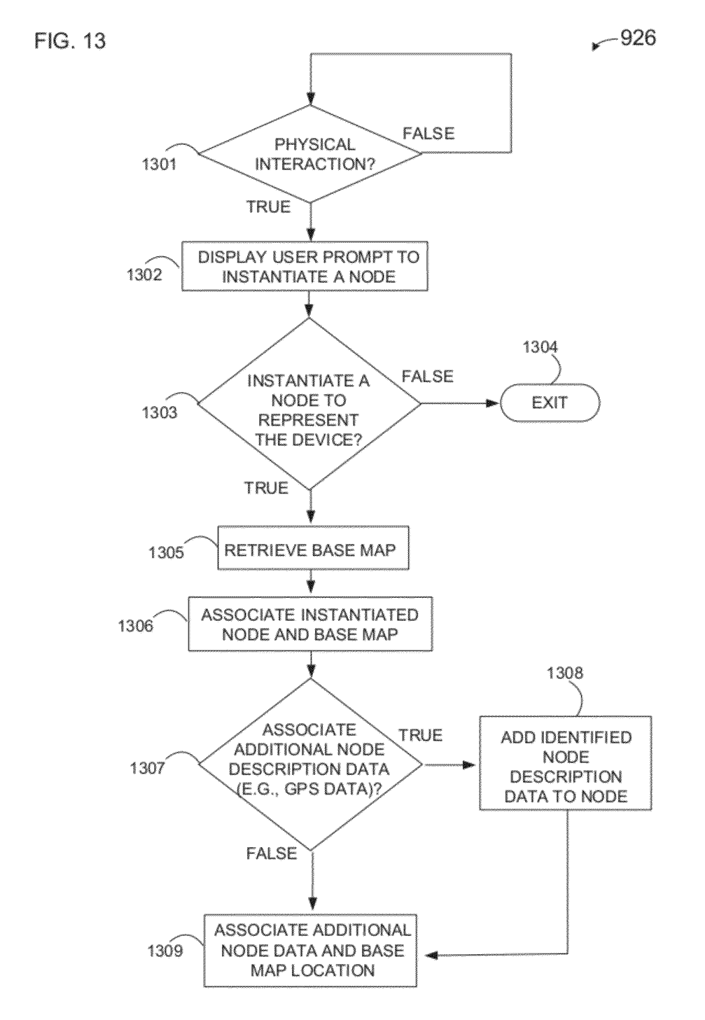

FIG. 13 is a flow chart illustrating an example method to implement the node designation logic 926. This node designation logic 926 may be implemented on the mobile computing device 110. Shown is a decision operation 1301 that determines whether a physical interaction has occurred between the mobile computing device 110 and a form factor with inductive charging and data transfer capabilities. This determination can be facilitated by bring a primary coil that is part of the form factor into proximity to a second coil that part of the mobile computing device 110 thus inducing voltage in the second coil. (See generally, U.S. Pat. No. 7,065,658 titled “Method and apparatus for synchronizing and recharging a connector-less portable computer system” which is incorporated by reference in its entirety.) Where voltage is induced, a voltage detector determines that voltage is flowing to the second coil denoting a physical interaction. In some example embodiments, a Hall-effect sensor is used in combination with the second coil to make the determination that a physical interaction has occurred. In cases where decision operation 1301 evaluates to “false,” decision operation 1301 is re-executed. In cases where decision operation 1301 evaluates to “true” operation 1302 is executed. Operation 1302 is executed to display a user prompt, prompting the user to instantiate a node on the personal map. This user prompt may take the form of a Graphical User Interface (GUI) or UI that is displayed on the screen 130 prompting the user to determine whether to add the node to the personal map. A decision operation 1303 is executed to determine whether to instantiate a node to represent the form factor that the mobile computing device 110 has had a physical interaction with as determined at decision operation 1301. The determination made by decision operation 1303 is facilitated by the user input from operation 1302, or via a pre-set default value. In cases where the decision operation 1303 evaluates to “true” an operation 1308 is executed. In cases where the decision operation 1303 evaluates to “false” a termination operation 1304 is executed. Operation 1305 is executed to identify or retrieve a base map. (See also Map Access Logic module 922.) Operation 1306 is executed to associate the instantiated node and the base map so as to identify a particular location on the base map, creating a personal map. Decision operation 1307 is executed to determine whether additional data is to be added to the personal map so as to additionally describe the node. This addition data may include GPS data, name data, a GUID value, IP address, MAC address, or other data to uniquely identify the node on the personal map. This determination may be facilitated through the use of a GUI to prompt a user to select the additional data from a menu, or other selection interface or mechanism. In cases where decision operation 1307 evaluates to “true,” an operation 1308 is executed. Operation 1308 is executed to get or retrieve the additional data from the mobile computing device 110, or over the communication link 203 from the network domain 204 and devices associated therewith. In cases where the decision operation 1307 evaluates to “false” an operation 1309 is executed to associate the additional data and the base map so as to further enhance the personal map.

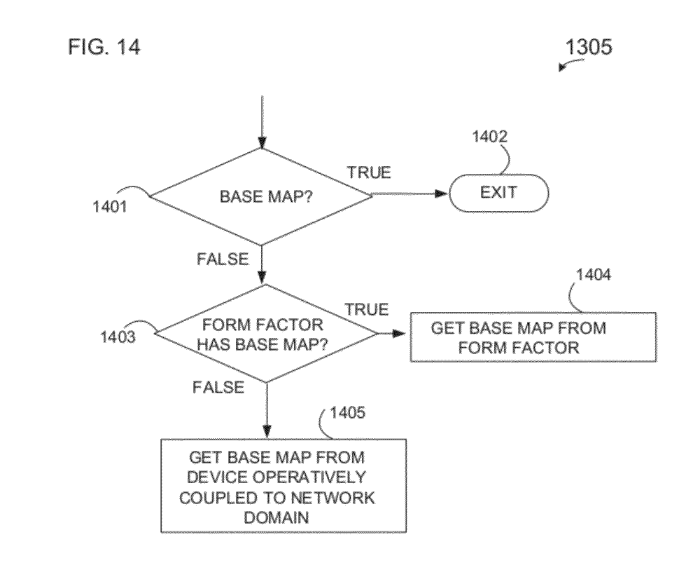

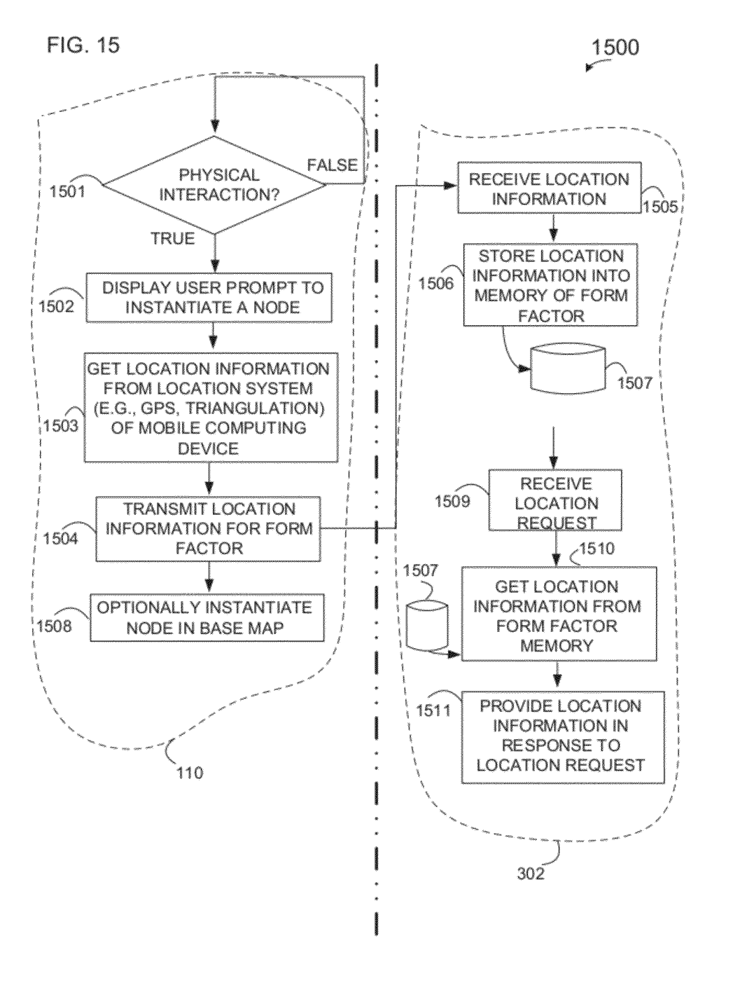

FIG. 14 is a flow chart illustrating an example method to execute operation 1305 that retrieves abase map. Shown is a decision operation 1401 that is executed to determine whether the mobile computing device 110 has the appropriate base map in memory. This determination can be made by comparing a base map identifier value against a form factor identifier value. Where the base map identifier value and the form factor identifier value are, for example, equivalent the decision operation 1401 evaluates to “true and a termination operation 1402 is executed. In some other example embodiments, some other suitable binary operation may be used in lieu of equivalence to determine whether the appropriate base map is in the memory of the mobile computing device 110. Where decision operation 1401 evaluates to “false” a decision operation 1403 is executed. Decision operation 1403 is executed to determine whether the form factor with which the mobile computing device 140 has had a physical interaction has the appropriate base map. In cases where decision operation 1403 evaluates to “true” an operation 1404 is executed. Operation 1404 is executed to get, retrieve the appropriate base map from the form factor memory. The base map may be retrieved via the wireless data connection that exists between the mobile computing device 110 and the form factor (see e.g., the inductive charging and data exchange station 201, the printer with inductive charging and data exchange capabilities 302, or the monitor with inductive charging and data exchange capabilities 402.). In cases where decision operation 1403 evaluates to “false” and operation 1405 is executed. Operation is executed to get, retrieve the base map from a device operatively connected to the network domain 204 and ultimately to the mobile computing device 140. Operatively connected includes a physical or logical connection. The device may be one or more servers, web servers, data base servers, mobile devices, network connected form factors, or other suitable device.

FIG. 15 is a dual-stream flow chart illustrating an example method to generate a personal network topology through assigning data to a form factor, allowing the form factor to know its location in a map. Shown are operations 1501-1504, and 1508 that are executed by the mobile computing device 110. Further, shown are operations executed by a form factor (e.g., the printer 302), these operations including operations 1505-1506, a data store 1507, and operations 1509-1511. Illustrated is a decision operation 1501 that determines whether a physical interaction has occurred between the mobile computing device 110 and a form factor with inductive charging and data transfer capabilities. This determination can be facilitated by bring a primary coil that is part of the form factor into proximity to a second coil that part of the mobile computing device 110 thus inducing voltage in the second coil. (See generally, U.S. Pat. No. 7,065,658 titled “Method and apparatus for synchronizing and recharging a connector-less portable computer system” which is incorporated by reference in its entirety.) Where voltage is induced, a voltage detector determines that voltage is flowing to the second coil denoting a physical interaction. In some example embodiments, a Hall-effect sensor is used in combination with the second coil to make the determination that a physical interaction has occurred. In cases where decision operation 1501 evaluates to “false,” decision operation 1501 is re-executed. In cases where decision operation 1501 evaluates to “true” operation 1502 is executed. Operation 1502 is executed to display a user prompt, prompting the user to instantiate a node on the personal map. This user prompt may take the form of a GUI or UI that is displayed on the screen 130 prompting the user to determine whether to add the node to the personal map. Operation 1503 is executed to get location information from a location system of a mobile computing device. This location system may use triangulation in combination with one or more of the following RF, cellular, or based upon protocol such as WiFi (802.11), WiMax (802.16), or some other suitable protocol. As shown by the execution of operation 1504, this location information is transmitted to a form factor. Operation 1505 is executed to retrieve the location information. Operation 1506 is executed to store the location information into memory 1507 of the form factor. Operation 1508 may be optionally executed to instantiate the node in a base map, or otherwise associate the node with a base map to make a personal map. Operation 1509 is executed to receive a location request, the location request provided to the form factor. Operation 1507 is executed to get the location information from the form factor memory 1507. Operation 1511 is executed to provide location information in response to the location request.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. A computer implemented method comprising:
detecting an inductively received electrical charge, the electrical charge received from a form factor capable of inductively charging and exchanging data with a mobile computing device;
displaying a user interface (UI) on the mobile computing device, the UI to receive input to instantiate a node that represents the form factor; and
associating the node with a map to be displayed on the mobile computing device.

2. The computer implemented method of claim 1, wherein the form factor is at least one of a printer, or a monitor.

3. The computer implemented method of claim 1, wherein the node is part of a personal network topology.

4. The computer implemented method of claim 1, further comprising receiving instructions via the UI to retrieve additional data, the additional data to describe the node as the node is displayed on the mobile computing device.

5. The computer implemented method of claim 4, wherein the additional data includes at least one of Global Positioning System (GPS) data, general location data, name data, Internet Protocol (IP) address, Media Access Control (MAC) address, or a Globally Unique identifier (GUID) value.

6. A mobile computing device comprising:
a coil capable of receiving an electrical charge from a form factor, the form factor capable of inductively charging and exchanging data with the mobile computing device;
a touch-sensitive screen capable of receiving input to instantiate a node that represents the form factor, the node part of a personal network topology; and
a memory to store the personal network topology associated with a map.

7. The mobile computing device of claim 6, wherein the personal map includes a floor plan.

8. The mobile computing device of claim 6, wherein the touch-sensitive screen receives instructions to retrieve additional data, the additional data to describe the node as the node is displayed on the touch-sensitive screen.

9. The mobile computing device of claim 8, wherein the additional data includes at least one of Global Positioning System (GPS) data, general location data, name data, Internet Protocol (IP) address, Media Access Control (MAC) address, or a Globally Unique Identifier (GUID) value.

10. The mobile computing device of claim 6, wherein the map is retrieved from the form factor.

11. A computer system comprising:
at least one processor;
a memory in communication with the at least one processor, the memory including logic encoded in one or more tangible media for execution and when executed operable to:
detect an inductively received electrical charge, the electrical charge received from a form factor capable of inductively charging and exchanging data with a mobile computing device;
display a user interface (UI) on the mobile computing device, the UI to receive input to instantiate a node that represents the form factor; and
associate location information for the node with a map to be displayed on the mobile computing device.

12. The computer system of claim 11, further comprising the memory including logic encoded in one or more tangible media for execution and when executed operable to transmit the location information to the form factor.

13. The computer system of claim 11, further comprising the memory including logic encoded in one or more tangible media for execution and when executed operable to get the location information from a location system.

14. The computer system of claim 13, wherein the location system uses triangulation and includes at least one of a Radio Frequency (RF) based location system, a cellular based location system, a WiFi based location system, or a WiMax based location system.

15. The computer system of claim 11, wherein the computer system is a mobile computing device.
